(19) United States
(12) Patent Application Publication
(10) Pub. No.: US 2017/0124786 A1
(43) Pub. Date: May 4, 2017

(54) METHOD FOR MONITORING A VEHICLE CONTROL

(71) Applicant: Robert Bosch GmbH, Stuttgart (DE)

(72) Inventors: Markus Waibler, Stuttgart (DE); Michael Hackner, Winterbach (DE); Nello Sepe, Unterensingen (DE); Juergen Sojka, Bietigheim-Bissingen (DE)

(73) Assignee: Robert Bosch GmbH, Stuttgart (DE)

(21) Appl. No.: 15/320,088

(22) PCT Filed: Jun. 9, 2015
(86) PCT No.: PCT/EP2015/062770

§ 371 Date: Dec. 19, 2016

(30) Foreign Application Priority Data
Jun. 20, 2014 (DE) 10 2014 211 896.4

(51) Int. Cl. G07C 5/08; G05B 23/02; G07C 5/00

(52) U.S. Cl. CPC G07C 5/0808; G07C 5/008; G07C 5/0816; G05B 23/0283

(57) ABSTRACT

A method for monitoring a vehicle control. Correction values are determined via a correction function. The characteristic of the correction values is recorded and extrapolated. An error is forecast based on the extrapolated correction values.

### FIELD OF THE INVENTION

The present invention relates a method for monitoring a vehicle control.

### BACKGROUND INFORMATION

Various learning, control and correction functions that monitor the functioning of systems and components in motor vehicles while traveling and intervene correctively in case of a deviation are known. For example, a method and device for controlling the running smoothness of an internal combustion engine are discussed in DE 431 9677. In the case of this device, each cylinder of the internal combustion engine is assigned a regulation that forms a control variable for the regulator assigned to the regulation depending on a control deviation assigned to the regulation. The control deviation results from the actual values and setpoint values assigned to the individual cylinders.

Production tolerances and runtime variations in the vehicle can be compensated by such a method. This keeps production costs low and improves driving comfort. These functions are generally part of the system software and are therefore implemented by the vehicle manufacturer in vehicle control units before the start of production. In the event of servicing, the correction values for the learning, control and correction functions can be employed to diagnose systems or components of the vehicle in the workshop.

Also believed to be understood are telematics applications that enable continuous or intermittent data transmission from the vehicle to the vehicle manufacturer, its service organization, or third parties.

If the determined correction values exceed a specific value in the known learning, control and correction functions, appropriate measures are introduced. Normally, the known functions only react when emission limit values or control limits have been exceeded. This is a reactive diagnosis, i.e., the vehicle operator notices a symptom in the form of a warning lamp, or a compensatory reaction such as limp-home operation or even a vehicle breakdown, and this generally comes as a surprise to the operator.

In a commercial setting, high subsequent costs are frequently associated with this type of vehicle breakdown. This is, for example, the case with construction vehicles or mining vehicles.

### SUMMARY OF THE INVENTION

The device and method according to the present invention having the features of the independent claims by contrast have the advantage that a timely warning is able to prevent an unplanned breakdown of the vehicle. In particular, the driver or vehicle operator is warned in a timely manner and is able to take appropriate measures in a timely manner.

It is particularly advantageous in this context that correction values are able to be determined via a correction function. The characteristic of the correction values is recorded and extrapolated. An error is forecast based on the extrapolated correction values. Any method can be used for extrapolation. Linear extrapolation may be used.

Of particular advantage is that it is determined when an error will probably occur. This means that the driver or operator is notified when the error is expected to occur. It may be provided that the remaining traveling distance and/or the remaining time until error occurrence are/is displayed.

It is particularly advantageous that notification is provided of the time at which the extrapolated correction values will probably exceed a threshold value. In the related art, the control unit checks if the threshold value has been exceeded. In the past, when the threshold value has been exceeded, the driver is notified of an error and appropriate measures are initiated. By performing a check to determine when the extrapolated correction value will exceed the threshold value, it is possible to determine in advance the point at which the error will probably occur.

It is advantageous if this is reported a certain period of time before the threshold value is reached. This means that a corresponding notification is conveyed to the driver or operator at a specific period of time A before the threshold value is exceeded. This period of time A may be chosen to be longer than a service interval. It may also be provided that this period of time A is set so that it is still possible to reach a workshop. In particular in the case of vehicles that regularly travel the same route, this time is set so that these vehicles are able to reach a workshop. This is particularly advantageous for public buses, shipping company vehicles, or vehicles that are used in mines, pits or stone quarries.

If the average traveling distance per time is known, a traveling distance may be used instead of the period of time. This is particularly useful in the case of vehicles that always travel the same or a similar distance, or range within a specific traveling distance from a service center.

The control unit effort is able to be reduced because the characteristic of the correction values is only extrapolated when the correction values assume values outside of a permissible range. Furthermore, the precision of the extrapolation is improved when the correction values have already increased significantly.

The described method is able to be performed entirely in a control unit in a vehicle. It is, however, particularly advantageous if the method is performed at least partially in a “cloud” outside of the vehicle. This is particularly advantageous when a plurality of vehicles is being monitored. This is the case, for example, with a fleet of a bus company or a shipping company. This is also advantageous when a plurality of vehicles of a company that operates a stone quarry or mine is monitored. In these instances, a future error is not displayed to the driver or is displayed not just to the driver but rather the future error is also displayed to the owner of the vehicles. This makes it possible to ensure that unanticipated breakdowns of the vehicles do not occur, and that they are brought to be serviced in a timely manner.

The present invention also relates to program code together with processing instructions for creating a computer program that is able to run on a control unit, in particular source code with compiler and/or linking instructions, with the program code producing a computer program for executing all steps of one of the described methods when it is converted into an executable computer program according to the processing instructions, i.e., in particular compiled and/or linked. In particular, this program code may be source code that, for example, is able to be downloaded from a server on the Internet.

Exemplary embodiments of the present invention are illustrated in the drawings and are described in greater detail in the subsequent description.

### BRIEF DESCRIPTION OF THE DRAWINGS

FIG. 1 shows a schematic representation of the present system.

FIG. 2 shows the time characteristic of the features.

FIG. 3 shows a flowchart of the present method.

### DETAILED DESCRIPTION

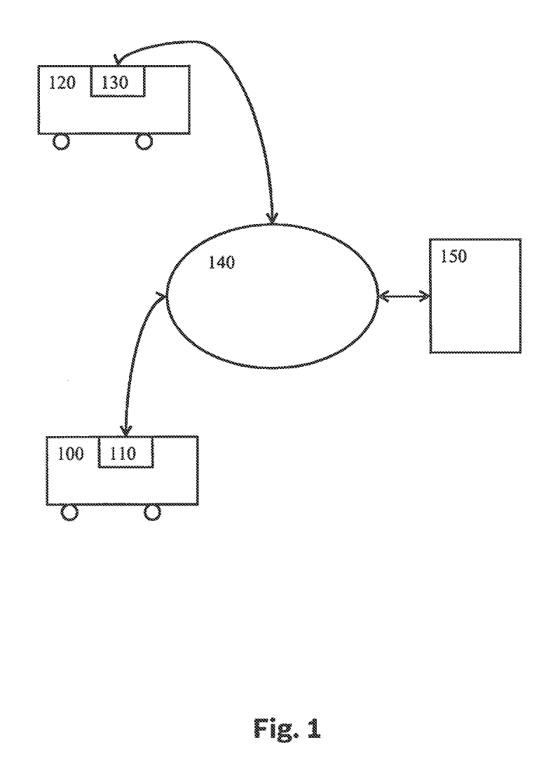

FIG. 1 shows a device for monitoring a vehicle control. A first vehicle is designated by reference numeral 100. This generally includes a control unit 110. Furthermore, additional vehicles 120 that may also include a control unit 130 may be provided. This vehicle 120 or control unit 110 transmits the data to a central unit 140. The central unit executes various calculations and exchanges data with a display arrangement 150.

This central unit may also be designated as a “cloud”. This refers to various memories and various computers having a decentralized or central location. For example, it may be provided that a service provider offers this storage capacity and the computer capacity, and the calculations are performed on the site of the service provider. Display arrangement 150 may be located with the vehicle owner or with the vehicle operator. In the case of a shipping company, it may, for example, be provided that these data are centrally retrievable via a computer and that corresponding individuals have access to these data.

Various correction data are collected in the context of controlling a vehicle. It is, for example, known from the indicated related art to determine the correction values of a so-called smooth running regulation system. Furthermore, modern engine control units are equipped with so-called zero quantity calibration. This zero quantity calibration determines the correction activation duration beginning with which fuel is injected in a torque-effective manner. The method according to the present invention may be used for all of these methods and other methods that are employed in engine control or that are employed in other controls in the internal combustion engine.

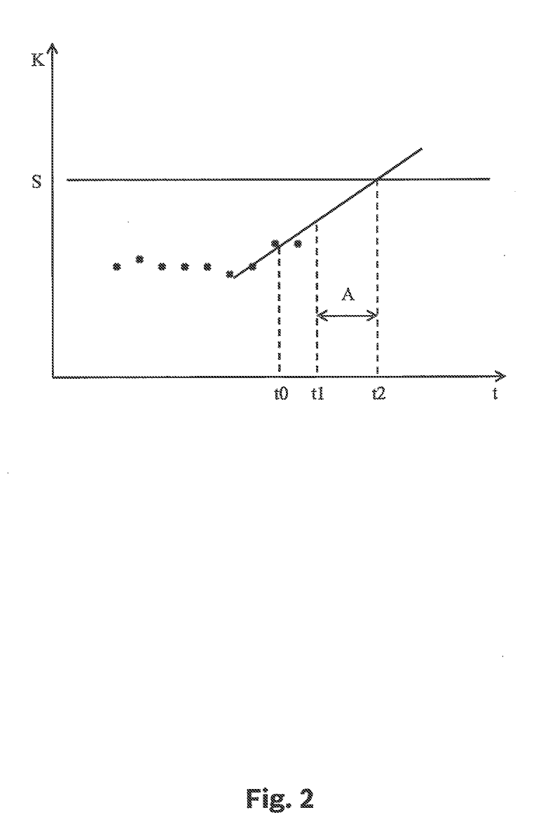

In FIG. 2 correction values K are plotted against time t. Furthermore, S designates a threshold value. Up until time t0, correction values K assume a nearly constant value. The correction values only fluctuate from measurement to measurement within a certain tolerance range. Starting from time t0, the correction values slowly increase. A straight line may be run through these increasing values, or an extrapolation curve may be plotted using other methods. At time t2, this extrapolation curve intersects threshold value S. Starting from this time t2, a time t1 that precedes time t2 by time interval A is determined. At time t1, a warning is emitted. This time interval A may be set such that it corresponds to the time interval during which the vehicle is normally serviced. That is, time interval A corresponds to the service interval of the vehicle.

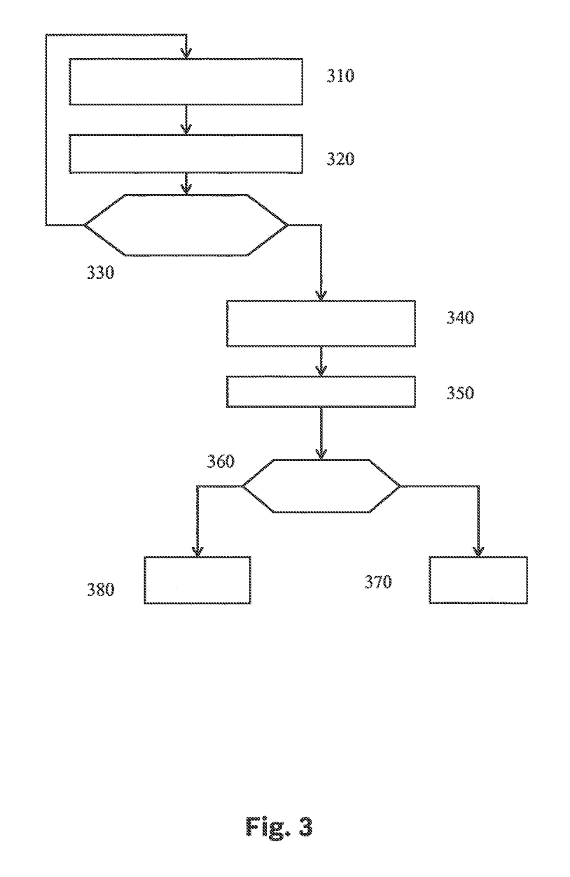

The method according to the present invention is described in the following with reference to the example in FIG. 3. In a first step 310, the correction values are determined. In a step 320, the correction values are saved in a memory. In a step 330, a check is performed to determine whether the correction values are within a specific range. If this is the case, the program continues with step 310, and new correction values are determined. If the spread of the correction values is greater than the specified range, a dynamic calculation of extrapolation values is performed in step 340. In the simplest case, this is performed by a linear extrapolation. However, any other mathematical extrapolation algorithms may be used. In step 350, the intersection of the extrapolation function with permissible limit value S is calculated. Permissible limit values S may be applied diagnostic limit values, physical control limit values of the correction function, or other limit values. Query 360 checks when the intersection is reached. Depending on the result of query 360, an error message is output in step 370, or notification is provided in step 380 that the vehicle will break down within a specific time or mileage.

It is particularly advantageous if the described method is performed at least partially in a so-called “cloud”. The correction values are determined in step 310 in control unit 110 of vehicle 100. These correction values are then transmitted by a telematics unit. An existing truck telematics box, a connectivity control unit with its own logic, or a GSM module in the control unit may be used as the telematics unit. The correction values may be preprocessed and/or buffered in the vehicle. In central unit 140, the correction values are transmitted to a server and may be saved in a database. From there, the data pass to any desired hardware, which processes the above method steps. The results are then appropriately displayed to the user or the owner of the vehicle.

It may alternatively be provided that the extrapolation also occurs in control unit 110, and that only the data are transmitted to the central unit when the threshold value is exceeded.

In an additional specific embodiment, the entire method may be carried out in the control unit.

Learning, control and correction functions are essential to the use of the approach according to the present invention. If these are not implemented and/or activated in control unit 130, one embodiment provides for these functions to run only at intervals in monitoring, but not regulating fashion, on central unit 140, i.e., in the “cloud,” as well. For this purpose, only all of the input signals necessary for learning, control and correction functions are transmitted to central unit 140.

1-10. (canceled)

11. A method for monitoring a vehicle control, the method comprising:
determining correction values by a correction function;
recording a characteristic of the correction values;
extrapolating the characteristic of the correction values; and
forecasting an error based on the extrapolated correction values.

12. The method of claim 11, wherein it is determined when an error will probably occur.

13. The method of claim 12, wherein notification is provided as to when the extrapolated correction values exceed a threshold value.

14. The method of claim 13, wherein this is reported a certain time prior to the threshold value being reached.

15. The method of claim 11, wherein the characteristic of the correction values is extrapolated when the correction values assume values outside of a permissible range.

16. The method of claim 11, wherein the method is performed at least partially in a central unit outside of the vehicle.

17. A computer readable medium having a computer program, which is executable by a processor, comprising:
a program code arrangement having program code for monitoring a vehicle control, by performing the following:
determining correction values by a correction function;
recording a characteristic of the correction values;
extrapolating the characteristic of the correction values; and
forecasting an error based on the extrapolated correction values.

18. The computer readable medium of claim 17, wherein it is determined when an error will probably occur.

19. A control unit for monitoring a vehicle control, comprising:
a determining arrangement to determine icorrection values by a correction function;
a recording arrangement to record a characteristic of the correction values;
an extrapolating arrangement to extrapolate the characteristic of the correction values; and
a forecasting arrangement to forecast an error based on the extrapolated correction values.

20. The control unit of claim 19, wherein it is determined when an error will probably occur.
